(19) United States
(12) Patent Application Publication
(10) Pub. No.: US 2008/0254404 A1
(43) Pub. Date: Oct. 16, 2008

(54) SYSTEM FOR MANAGING CUTTING TOOLS

(75) Inventor: Roger Heraud, Avensan (FR)

Correspondence Address: PERMAN & GREEN, 425 POST ROAD, FAIRFIELD, CT, 06824, US

(73) Assignee: XELYX, Blanquefort (FR)

(21) Appl. No.: 11/871,287

(22) Filed: Oct. 12, 2007

(30) Foreign Application Priority Data
Apr. 13, 2005 (FR) 05 50940

(51) Int. Cl. A61C 1/00; A61C 3/02; B23Q 17/09

(52) U.S. Cl. 433/27; 433/131

(57) ABSTRACT

The invention concerns a system (1) for managing rotary cutting tools (2,2a,2b. . . ) mounted on a motor-driven appliance (7) receiving and driving the rotary cutting tools designed to manage dentist's files comprising mainly: first identifying means (6, 8) for identifying the cutting tools, means for recording (8) reference data of each cutting tool identified by the first identifying means (6,8), means (9a, 9b) for transmitting preprogrammed values of the cutting tool to the motor-driven appliance (7), means (9a, 9b) for transmitting measurements of the operating conditions of the cutting tools from the motor-driven appliance (7) to recording means (8), means for evaluating the fatigue of the cutting tools, a computing device (12) adapted to compute a fatigue level of the cutting tools based on the reference data recording means (8) and the evaluating means.

### BACKGROUND

1. Field

The disclosed embodiments concern a system for managing cutting tools and particularly for managing and monitoring dentists' rotary files.

2. Background

The disclosed embodiments are particularly suited to managing nickel-titanium dentists' files. The use of nickel-titanium files in the dental field has become more and more important, despite the fact that the functional limits of these files are poorly determined, in particular their fatigue or wear limits, which can lead to breakage.

These limits are difficult to assess, since they are dependent on several parameters including the load on the files during their operation and their rotational speed.

Document EP 1,400,217 A1 describes a method for evaluation of file fatigue based on counting the number of rotational cycles of the file in use.

The method described in this document, however, does not measure the different dynamic stresses placed on the file during work or operation, stresses which depend on pressure applied by the practitioner on the file, the hardness of the dentin, or the cutting force.

This method also does not measure file fatigue in a secure manner, since fatigue, which is distributed among the different parts of the conical section of the file, remains undetermined in terms of application time of the stresses and where the stresses are applied, and significant errors are generated.

According to the prior art, these stresses that are not quantified are replaced by preset weighted coefficients, so that the evaluation of fatigue that the file experiences is left to the assessment of the practitioner.

An important source of error regarding the wear of files is therefore not dealt with, and, as a precaution, practitioners would have a tendency to prematurely discard numerous files.

Moreover, dentists' files are sold by cases holding a sequence of files and often the practitioner regularly replaces entire cases in order not to make a mistake due to the state of wear of one file of a sequence.

The safety of use of these instruments and their rational management in terms of wear and fatigue depends on an overall management and monitoring system and, to do this, the present invention comprises a management system better responding to the definition of wear and fatigue, since it automatically encompasses the parameters of the files and their wear.

### SUMMARY

To do this, the disclosed embodiments principally concern a management system for rotary tools mounted on a motor-driven appliance that holds and drives the rotary cutting tools,

characterized in that it comprises:

first identifying means permitting identifying the cutting tools,

means for recording reference data for each cutting tool identified by the first identifying means,

means for transmitting the preprogrammed values for the cutting tool to the motor-driven appliance,

means for transmitting measurements of the operating or work conditions of the cutting tools from the motor-driven appliance to the recording means,

means for evaluating the fatigue of these cutting tools,

a data processor designed to calculate fatigue of the cutting tools from

the reference data recording means and evaluating means.

More particularly, the system according to the invention also comprises:

measurement means associated with the motor-driven appliance and designed to measure the operating or work conditions of the cutting tools, each measurement being associated with a tool via the first identifying means,

means for transmitting the operating or work condition measurements of the cuffing tools from the motor-driven appliance to the recording means,

the data processor cooperating with the recording means, in order to calculate wear on the cutting tools from the recording of the operating or work conditions of the cutting tools.

According to the disclosed embodiments, the parameters of wear such as pressure by the practitioner on the file, the hardness of the dentin, the type of file, the cutting force, the bending of the file and also the curvature of the tooth, which are defined automatically or manually according to a value scale, are taken into account by the system for calculating the wear of cutting tools.

Thus the system of the disclosed embodiments permits automated management of files in an overall manner, since it manages the files throughout their service life, when in use, when being decontaminated or in storage.

Advantageously, the system according to the disclosed embodiments manages sequences of files, which facilitates their use, and automatically regulates the dental treatment appliance driving the files.

### DESCRIPTION OF THE FIGURES

Other characteristics and advantages of the disclosed embodiments will be better understood upon reading the description that follows of nonlimiting examples of embodiments in reference to the drawings, which show:

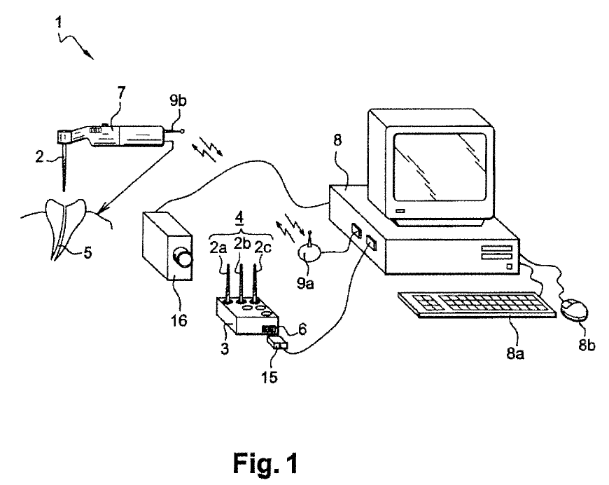

in FIG. 1: a schematic view of a system according to the disclosed embodiments;

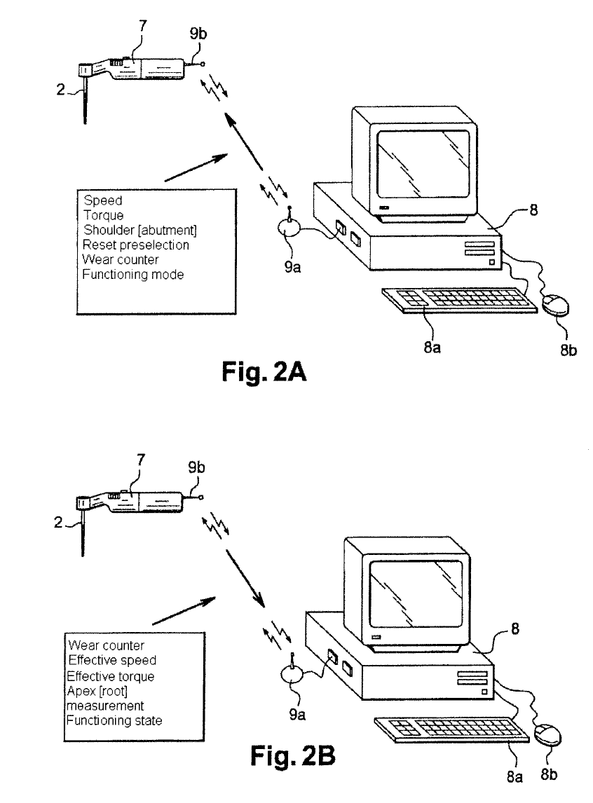

in FIGS. 2A and 2B: two data transmission phases in the system of FIG. 1;

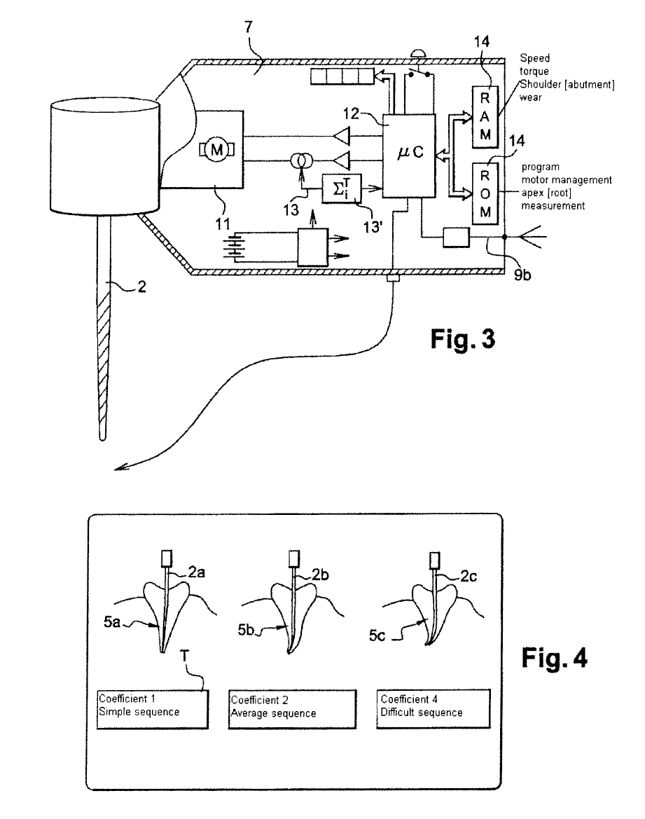

in FIG. 3: an exploded schematic view of an example of an appliance according to the system of the disclosed embodiments;

in FIG. 4: a screen showing root canals according to their difficulty;

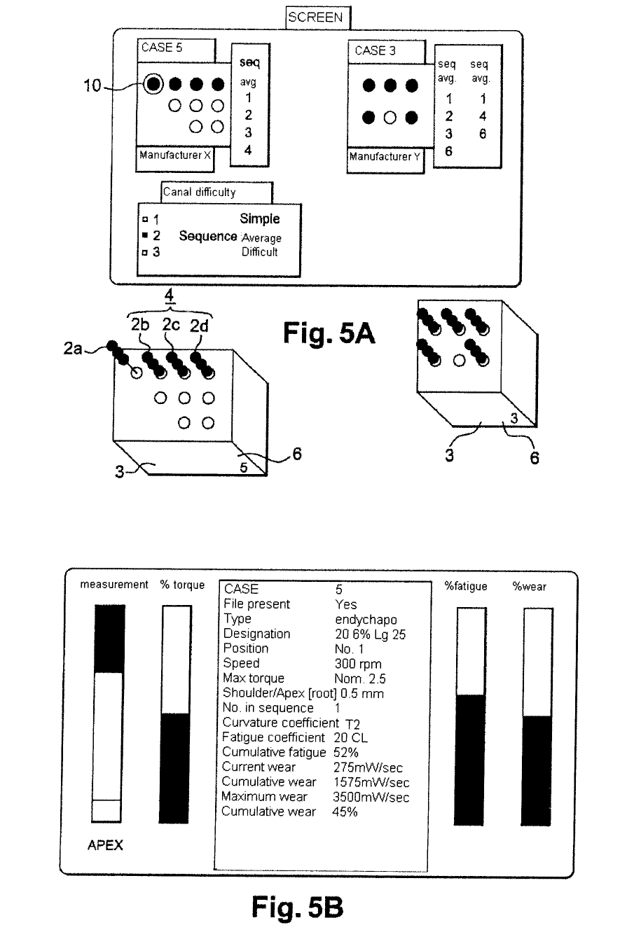

in FIGS. 5A and 5B, respectively: a view showing a screen for selecting files and corresponding cases and a view of a screen consolidating the parameters of a file and an operation to be conducted.

### DETAILED DESCRIPTION

The system 1 for managing rotary cutting tools according to the invention diagramed in FIG. 1 is particularly well suited to management of dentists' files. This system principally comprises a computer 8, a dental treatment appliance 7, and means 9a, 9b for connecting the computer and the dental treatment appliance.

Dental files 2, 2a, 2b, etc., which can originate from different manufacturers, are generally arranged in cases 3 in given positions according to manufacturers' standards, or customized by the practitioner to make up file sequences 4 suited to the dental operation to be conducted.

The files are arranged in cases 3 in positions defined by these sequences, which determine their order of passage into dental root canal 5.

A case 3 can comprise one or more sequences.

Within the scope of the invention, each case is referenced by a unique identifier 6 that can be a number, a code, a color or a different reference for each case, which is applied onto cases 3, the system having first identifying means comprising either the identifier 6, or the identifier 6 combined with means 15 for recognizing the identifier and computer 8, these identifying means comprising means for storing reference data identifying said cutting tools, sequences and cases, and means for displaying a representation of said cutting tools, sequences, and cases.

The reference data particularly comprise preprogrammed parameters or values for the files.

The system works on any number of cases and files, since the computer stores the parameters for each file position in each case and the parameters for all the cases referenced by the practitioner.

The preprogrammed parameters or values for each file include, in a non-exhaustive manner, case code, file type, sequential code, speed, torque, shoulder [abutment], wear, fatigue, wear limit, fatigue limit, curvature coefficient, file present or not, discarded or not.

Computer 8 stores the file sequences in memory, i.e., the order in which the files will be used as a function of the difficulty of passage into the canals, for each manufacturer or for the customized sequences of the practitioner, and for each case.

In the system according to the invention, a comment field is available for each case to differentiate the particular features of these cases, for example: “customized case with modified sequence”, “case consolidating sequences n, p”, or other particular information. An example of how the cases are displayed on the screen is given in FIG. 5A.

Dental canal treatment appliance 7 is connected by wire, infrared communication or wireless connection to the computer for transmission of data relating to the files used and the operation to be conducted.

The treatment appliance shown in FIG. 3 principally comprises a motor 11, a data processor 12, memory means 14, transmitter/receiver means 9b for transmitting data and measurement means 13 designed to measure the operating parameters for file 2.

The system manages all cases 3 and files 2 so that the files present are displayed, the files missing are erased from the screen and the files to be discarded are identified (for example, displayed in red).

More precisely, and in reference to FIG. 5A, when an operation has been determined, the computer displays one or more cases that can be used for this operation from a menu activated by a keyboard 8a or a pointing device, such as a mouse 8b, and, when the cases are present, displays the files in the cases.

The practitioner then puts the physical file case or cases whose reference 6 corresponds to the numbers displayed on the screen on his workstand.

Once the system is provided with first identifying means 6, computer 8 and possibly reader 15 are set up to individually identify cutting tools 2, 2a, 2b, etc. in cases 3, and combine reference data and said representative values with these files in a bijective manner.

For root canal operations, an important parameter is the root canal curvature. This parameter is important for evaluating file fatigue.

When a case holds several sequences, the curvature coefficient of the canal or the choice of the sequence determines the series of files [to be used] and their positioning, for example 1, 2, 3, 6 or 1, 4, 6.

Within the scope of the disclosed embodiments, a curvature coefficient determined by the shape of the canal is applied, this coefficient T being graduated, for example, on a scale of values from 1 to 5. A representation of the various dental canal curvatures displayed on the screen as a function of coefficient T is given in FIG. 4.

Three root canal curvatures 5a, 5b, 5c are shown in this figure, respectively corresponding, for example, to files 2a, 2b, 2c with respective coefficients 1, 3 and 5.

For the same file, the [different] curvatures will induce different fatigues.

In order to evaluate file fatigue as a function of curvature, an average number of operations for each file and each canal curvature is defined according to laboratory tests, which are conducted under the same conditions and parameters as those present during actual use, by evaluating the file fatigue up to the breaking point for each canal type. This average number of operations permits determining for each type of file a coefficient CL for each type of operation and for each file.

According to the disclosed embodiments, this coefficient CL serves to automatically define the case to be used according to the sequence corresponding to a given canal curvature, or is used to select the files according to the sequence in a case holding files for all curvatures.

As described above, the coefficient CL defines for each file a fatigue value for each type of operation. In the system, a table of CL coefficients is stored in memory along with the file parameter for each type of operation T representative of a given canal curvature, and from these the difficulty of an operation is determined.

In order to measure file fatigue so as to alert the practitioner that the file has reached its limits, the device has means for evaluating the fatigue of the file that comprises an operation of summing the numbers for the operations conducted, which are weighted by coefficient CL allocated for each operation, and it comprises means for comparing this summation to a maximum value for each file stored in memory.

By taking 100 as a numerical value for the fatigue limit for each file (or a fatigue level of 100%), the table of coefficients CL representative of a number of operations per curvature value, which may be weighted by a safety coefficient, will permit calculating a fatigue value for each operation.

For example, for clarification, for a given file, in the case of a simple curvature (type 1 curvature) the number of canals that can be treated may be 20. The value CL1 will therefore be equal to 5 for a maximum fatigue value set at 100. For a difficult curvature (type 5 curvature), the number of canals that can be treated may be reduced to only 2 canals, or a CL5 coefficient equal to 50.

A representation of cumulative file fatigue will be the value obtained after an accumulation of operations (n1×CL1+n2×CL2+. . . ); this value is compared with the fatigue limit and the file is marked for disposal when the value obtained surpasses the fatigue limit specified before the file breaks.

Thus, before the operation, the system asks the practitioner to give the type of operation T to be carried out by presenting the screen of FIG. 4, in order to automatically propose the one or more cases that hold(s) a suitable sequence for conducting the operation and whose files have a sufficient capacity in terms of fatigue margin to conduct the operation. Once this operation has been performed, the display screen is the one shown in FIG. 5A, the file proposed by the system being the file marked by a visual reference 10 on the screen.

In order to proceed, after the practitioner has determined the curvature of the tooth and enters it into the system and before he works with the file, the fatigue provided for the file is added to the cumulative value of prior fatigue of the file recorded in the system, which permits informing the practitioner of the remaining capacity of the file, and whether or not the operation can be conducted with this file.

If the operation cannot be conducted by the file selected manually, the system will propose a new file or another case containing a file that can perform the operation, and this procedure will be conducted automatically as a function of discards, file or case availability and according to the position in the sequence.

On the screen, in addition to displaying the case, the selection of the first file will be defined by the beginning number of the sequence, [shown as] visual reference 10 for the file 2 to be used (for example, a colored circle surrounding the file representation on the screen).

In contrast, if the practitioner selects a case 3 having a single file sequence, the curvature of the canal will be automatically defined in this case, the file sequence being provided for a given curvature.

The sequences currently used are sequences of 3 files for 3 levels of difficulty. However, it is possible to extend the sequences up to 5 files or even more to correspond to increasing coefficients of difficulty such as defined above.

In practice, when the practitioner chooses a case or a sequence, he validates one of the cases on the screen, the file beginning a sequence is surrounded by a red circle, and then the practitioner positions the physical file from the case on the treatment appliance.

The practitioner can select another file by clicking on an icon representing it, if desired.

In particular, according to the disclosed embodiments, for each case 3 and for each sequence of the case, the order of use of cutting tools 4 is recorded in recording means 8 either as a function of the difficulty of the passage through the canal or the wish of the practitioner.

When the selection of the file and its parameters are detected, the file management system displays the parameters of the operation and of the file as shown in FIG. 5B and sends the preprogrammed values of the file in question and of the operation to be conducted to the treatment appliance via transmission means 9a, 9b, i.e.:

the torque that it can support,

its nominal speed,

the position of the canal shoulder [abutment],

the resetting of the wear memory for the dental treatment appliance.

The dental treatment appliance is then ready to conduct the operation on the tooth.

During the operation, the quantification of wear simultaneously experienced by the file due to the pressure exerted by the practitioner, the rotational speed, the diameter of the file, the hardness of the dentin, the cutting force of the file, and the bending, according to the invention, is represented by an approximation corresponding to the integral of the measurement of the instantaneous current measurement value minus the instantaneous losses.

According to the disclosed embodiments, in order to quantify this wear, measurements of the operating or work conditions, including a measurement of the motor torque of motor-driven appliance 7, are conducted.

In order to do this, data processor 12, measurement means 13, 13′ and memory means 14 are set up to measure the instantaneous current and to subtract losses at given intervals and to produce a measurement of the instantaneous work on the file and then a summation of this work measurement that provides a representation of the work or operation and the wear of the file, a representation that is stored first in memory 14 of appliance 7 and then in the memory of computer 8 after transmission from dental appliance 7 to the computer.

The losses are due notably to motor friction and the counter angle that can be measured empirically.

According to one mode of embodiment, the measurement of instantaneous current and losses is obtained from monitoring the pulse width modulation (known by the English acronym PWM) controlling the treatment appliance motor, or by other methods, such as measuring the current by means of a resistor positioned in the power circuit of the motor.

Data processor 12, such as a microprocessor or a microcontroller, and measurement means 13, 13′ conduct the current measurement and the subtraction of losses, which gives a value that can particularly be evaluated in milliwatts per second, and create a cumulative sum of the measurements (instantaneous current-losses) at regular intervals, for example every 20 milliseconds, the resulting cumulative sum being stored in memory and then used to give a representation of the operation or work and therefore the wear on the file.

In practice, the summation of the work values is only conducted when motor 11 rotates, in forward operation or in backward operation, whether or not the file is inserted in the canal.

The file wear memory is reset after transfer of the cumulative value representing the work of the file from the appliance to the file management system computer, and upon request of the file management system, when a file is changed.

During the operation on the tooth, file wear is accumulated in memory 14 of appliance 7 until the end of the operation conducted by the file.

According to one variant, the work value representing the wear of the file is continuously transmitted to computer 8.

An example of data transmission to dental treatment appliance 7 before operation is shown in FIG. 2A; an example of data transmission after operation is shown in FIG. 2B

The work value, possibly adjusted by a coefficient, is added to the values corresponding to prior uses of this same file to obtain the cumulative wear of this file throughout its usage cycles.

Alternatively, the transmission can be effected as soon as the file work or operation is terminated, particularly if data transmission during the actual operation is not possible, for example, in the case of an infrared transmission between the appliance and the computer or in the case of a wireless device with electric connection made by positioning the appliance on a charger.

An adjustment with display on the computer permits modifying the cumulative wear limit threshold and/or the fatigue limit for each file or for all the files of the same type (even when positioned in different cases).

As seen previously in reference to FIG. 5B, the system permits displaying on the screen the fatigue value of a file, the cumulative fatigue value, and the cumulative wear value (which can be in percentage of the wear limit). When fatigue and/or wear of a file reaches 100% of the corresponding limit, the file must be discarded. This information can be transmitted to the treatment appliance for display and/or, for maximal security, it can act on the functioning of the appliance, which can be automatically interrupted in order to stop or prevent the use of the file that is to be discarded.

The fatigue is calculated by summing the number of operations conducted, which are weighted by a difficulty coefficient, the evaluating means comprising means for comparing this summation with a maximum value stored for each file.

A sound or light signal can alert the practitioner that this threshold is being approached or has been surpassed and, in the case where the threshold is surpassed, the system will prevent the use of the file for the operation to be conducted.

When the operation with the file is terminated, if the cumulative wear surpasses the wear limit threshold of this file, the system alerts the practitioner so that the file is discarded and replaced.

The system can also prevent the use of a file that has reached its maximum wear or maximum fatigue.

Since the system has means for each file for summing the wear values from all the uses of the file and storing a value representing the cumulative wear of the file, and has means for comparison of this summation to a maximum value stored for each file in order to discard this file or trigger an alert in case the maximum stored value is surpassed, it permits removing a file from the list of files in a case.

In order to aid the practitioner, the system has means 10 for selecting and visually indicating a case and a file to be used as a function of the remaining fatigue capacities of the files, the discards, and the availability of files and cases whose sequence is compatible with the curvature of the canal to be treated.

When a discarded file is replaced, the operator will inform the system:

either the fact that the file has been replaced by a brand new file placed in the case in the position of the old file, in which case the cumulative fatigue counter for this file will be reset,

or the fact that the file has been replaced by a file coming from another case, in which case the system, informed of the origin of the new file, will transfer the data and parameters of this file from the original case to the new case,

or finally the fact that the file was discarded and not replaced.

In this last case, the computer then erases the data for this file and erases the screen.

The use of the system is described below.

During a given operation and as a function of canal curvature data T entered into the system by the practitioner, a sequence is provided by the system and is displayed on the screen (FIG. 5A).

A visual indicator 10 on the screen guides the practitioner so that he validates, by means of the keyboard or mouse of computer 8, the file identified by the system and corresponding to the sequence defined by the curvature coefficient.

At this stage, the practitioner can choose another file and validate it.

Then, the practitioner puts the file corresponding to his selection on the treatment appliance.

The preprogrammed values for the file chosen are then transmitted to the treatment appliance (FIG. 2A) and the work cycle begins.

Once work with the file is considered terminated, the data are retransmitted from appliance 7 to computer 8 (FIG. 2B) and the system indicates the next file of the sequence in the same way so that the next work cycle can begin.

When the complete operation is finished, the files and cases are cleaned and placed into the autoclave without mixing the files among the cases.

For the system according to the disclosed embodiments to operate correctly, the files must take their respective positions in cases 3.

The files can be returned to their defined position after they are used and decontaminated, or they can be returned to their original case before decontamination and then the whole case will be decontaminated.

When the practitioner deselects a case 3 on the screen, the system records the parameters of this case and classifies it for a subsequent use.

According to the system, several management methods for the cases are possible.

A copy of a case can be made by giving the physical number of the case, identifying the sequence, whether this sequence is standard or customized, entering the values associated with the files, and whether they are standard or customized according to the case.

When a case is finally discarded, it can be removed from the system.

The system permits the practitioner to program the parameters for each position of the file and to program customized cases with files from different manufacturers.

A menu on the screen permits validating the movement of a file from one case to another.

For this, the two cases are called up on the screen by their codes, the file from one case is selected by the system pointer (computer mouse, for example) and it is moved into the other case on the screen. During this operation, the parameters associated with the file that is moved are transferred from the memory representing the initial case to the memory consolidating the parameters of the destination case. This operation can be conducted on a screen similar to that of FIG. 5A.

According to one advantageous embodiment, the means for identifying the cutting tools comprise a camera 16 connected to the computer in order to display the physical cases of files positioned in front of the camera and a recognition program for the case using device 15 for recognition of the number or code of the case shown on the screen, the system combining camera 16 and recognition device 15, which can be said camera being adapted to display the position of the file used and to associate the stored reference data or values representing the files with this position in the memory of the computer.

Like the first identifying means, second identifying means camera 16 and computer 8 are set up to individually identify cutting tools 2, 2a, 2b, etc. in cases 3 and combine said representative values with them in a bijective manner.

The second identifying means comprise means for storing reference data identifying said cutting tools, sequences and cases in computer 8 and means for displaying a representation of said cutting tools, sequences and cases.

When a file is taken from a case and placed in the treatment appliance, it is immediately marked as used on the screen and its preprogrammed values are automatically transmitted to the treatment appliance.

The invention is not limited to the example shown, and in particular, the device can be supplemented by management means for tracking file stocks.

1. A management system (1) for rotary cutting tools (2, 2a, 2b, etc.) mounted on a motor-driven appliance (7) receiving and driving the rotary cutting tools,
comprising:
first identifying means (6, 8) permitting identifying the cuffing tools,
means (8) for recording reference data for each cutting tool identified by first identifying means (6, 8),
means (9a, 9b) for transmitting preprogrammed values for the cutting tool to motor-driven appliance (7),
means (9a, 9b) for transmitting measurements of the operating or work conditions of the cutting tools from motor-driven appliance (7) to recording means (8),
means for evaluating the fatigue of the cuffing tools,
a data processor (12) designed to calculate the fatigue of cuffing tools from reference data recording means (8) and the evaluating means
and in that the operating or work condition measurements comprise a measurement of the motor torque of the motor-driven appliance consisting of a measurement of the instantaneous current and losses.

2. The management system according to claim 1, further characterized in that it also comprises:
measurement means (13, 13′) associated with motor-driven appliance (7) and designed to measure operating or work conditions for the cutting tools, each measurement being associated with a tool via primary identifying means (6, 8),
means for transmitting the measurements of the operating or work conditions of the cutting tools from motor-driven appliance (7) to recording means (8),
data processor (12) cooperating with recording means (8) to calculate a wear value for the cutting tools from the recording of the operating or work conditions of the cutting tools.

3. The management and monitoring system according to claim 1, further comprising that motor-driven appliance (7) is a dentists' file holder, cutting tools (2, 2a, 2b, etc.) being dentists' files.

4. The management system according to claim 1, further comprising in that the fatigue is calculated by summing the number of operations conducted, which are weighted by a difficulty coefficient, the evaluating means comprising means for comparing this summation to a maximum stored value for each file, which, when it is surpassed, prevents the file from being used for the operation to be conducted.

5. The management system according to claim 1, further comprising that, for each case (3) and for each sequence of the case, the order of use of cutting tools (4) is recorded in recording means (8) either as a function of the difficulty of passage into the canal or the wish of the practitioner.

6. The management system according to claim 1, further comprising in that first identifying means (6, 8) and/or second identifying means (8, 16) are set up to individually identify cutting tools (2, 2a, 2b, etc.) in cases (3) and to associate reference data and said representative values with them in a bijective manner.

7. The management system according to claim 6, further comprising the identifying means comprise a reading device such as an optical reader, a radiofrequency reader or a camera and a corresponding coding means associated with said cases (3).

8. The management system according to claim 6, further comprising that first and/or second identifying means (6, 15, 16, 8) comprise means for storing reference data identifying said cutting tools, sequences and cases and means for displaying a representation of said cutting tools, sequences and cases.

9. The management system according to claim 1, further comprising in that the current is measured by measuring the pulse width of the pulse modulation control driving the motor of the treatment appliance.

10. The management system according to claim 9, further comprising that the data processor and the memory means are set up to conduct measurement of the instantaneous current and subtraction of losses at given intervals in order to produce an instantaneous measurement of the work of the file, a summation of this work measurement providing a representation of the work or operation and of the wear of the file stored in memory.

11. The management system according to claim 10, further comprising in that the given intervals are regular intervals.

12. The management system according to claim 10, further comprising that the data processor is set up only to conduct the summation if the motor rotates.

13. The management system according to claim 1, further comprising that it comprises for each file, means for summing the wear values from all the uses of the file and storing a value representing the cumulative wear of the file, and in that it comprises means for comparison of this summation to a maximum stored value for the file, in order to discard this file or trigger an alert in the case when the stored maximum value is surpassed.

14. The management system according to claim 10 further comprising visual means (10) for selecting and indicating a case and a file to be used as a function of the remaining fatigue capacities of files, discards, and the availability of files and cases, whose sequence is compatible with the curvature of the canal to be treated.
